(19) United States
(12) Patent Application Publication
(10) Pub. No.: US 2025/0056356 A1
(43) Pub. Date: Feb. 13, 2025

(54) SERVICE CONTINUITY GUARANTEED HANDOVER AMONG RADIO ACCESSES

(71) Applicant: GOOGLE LLC, Mountain View, CA (US)

(72) Inventors: JJ HuangFu, Mountain View, CA (US); Po-Chun Lee, Mountain View, CA (US)

(21) Appl. No.: 18/797,974

(22) Filed: Aug. 8, 2024

Related U.S. Application Data
(60) Provisional application No. 63/519,202, filed on Aug. 11, 2023.

(30) Foreign Application Priority Data
May 24, 2024 (IN) 202441040445

(51) Int. Cl. H04W 36/14; H04W 36/18; H04W 76/30

(52) U.S. Cl. CPC H04W 36/14; H04W 36/185; H04W 76/30

(57) ABSTRACT

A core network (CN) can implement a method for performing handover enhancement among different accesses. The method includes: establishing (410), via a first access node, a first communication session with a user equipment (UE); receiving (413), from the UE via a second access node, a request to establish a second communication session; transmitting (414), to the UE via the second access node, an acceptance to the request; starting (420), responsive to the receiving of the request, a retransmission timer; and in a first instance (251), responsive to receiving (417) an acknowledgement, from the UE via the second access node, that the second communication session is established: stopping (424) the retransmission timer, and stopping (419) communication with the UE via the first communication session; in a second instance (253), responsive to the retransmission timer expiring (225), retransmitting the acceptance (415).

### CROSS-REFERENCE TO RELATED APPLICATIONS

This application claims priority to and the benefit of the filing date of provisional U.S. Patent Application No. 63/519,202 entitled “SERVICE CONTINUITY GUARANTEED HANDOVER AMONG RADIO ACCESSES,” filed on Aug. 11, 2023. The entire contents of the provisional applications are hereby expressly incorporated herein by reference.

### FIELD OF THE DISCLOSURE

This disclosure relates generally to wireless communications and, more particularly, the mechanism of handover enhancement among different accesses to guarantee the service continuity.

### BACKGROUND

This background description is provided for the purpose of generally presenting the context of the disclosure. Work of the presently named inventors, to the extent it is described in this background section, as well as aspects of the description that may not otherwise qualify as prior art at the time of filing, are neither expressly nor impliedly admitted as prior art against the present disclosure.

For telecommunication systems, the control signal and data can be transmitted over multiple radio accesses. For example, the control signal and data can be transmitted over 3GPP access (e.g., long term evolution (LTE) in 4G, new radio (NR) in 5G, etc.) and/or Non-3GPP access (e.g., internet key exchange (IKE) tunnel (IKE security association (SA)) between a user equipment (UE) and evolved packet data gateway (ePDG) in 4G, non-third generation partnership project interworking function (N3IWF) in 5G through WiFi access, etc.).

Before transmitting user data, the UE and the network establish a packet (or public) data network (PDN) connection (e.g., in a 4G system) or a protocol data unit (PDU) session (e.g., in a 5G system). In some specific scenarios, the UE performs a handover of the PDN connection/PDU session between two different access nodes (also referred to herein as “accesses”). For example, the UE moves out of WiFi coverage, then the UE triggers a PDU session/PDN connection handover from non-3GPP access to 3GPP access. The UE and network may establish the connection according to various predetermined protocols and/or techniques, depending on the nature of the handover, (e.g., according to: (i) 3GPP technical specification (TS) 24.501, section 6.1.4 for 4G 3GPP (S1 mode) access to and from 5G 3GPP (NI mode) access; (ii) 3GPP TS 23.502, section 4.11.4.1 and TS 24.501, section 6.1.5 for 4G non-3GPP access (cPDG) to 5G 3GPP access; (iii) 3GPP TS 23.502, section 4.11.4.2 and TS 24.302, section 7.2.2 for 4G non-3GPP access (ePDG) from 5G 3GPP access; (iv) 3GPP TS 24.501, section 6.4.1 for 5G non-3GPP (NI mode) access (N3IWF) to 5G 3GPP access; (v) 3GPP TS 24.501, section 6.4.1 and TS 23.502, section 4.11.3.1 for 4G 3GPP access to 5G non-3GPP access; (vi) 3GPP TS 24.501, section 6.4.2 and TS 23.502, section 4.11.3.2 for 4G 3GPP access from 5G non-3GPP access; (vii) 3GPP TS 24.501, section 6.4.1 for 5G 3GPP access to 5G non-3GPP access; (viii) 3GPP TS 24.302 section 7.2.2. for 4G 3GPP access to 4G Non-3GPP access; and (ix) 3GPP TS 24.301, section 6.5.1 for 4G Non-3GPP access to 4G 3GPP access).

In 5G 3GPP access (NI mode), when there is an existing PDN connection/PDU session, the UE can initiate the PDU session establishment procedure with request type set to “existing PDU session” (e.g., as specified in 3GPP TS 24.501, sections 6.4.1 and 6.1.5). In some such implementations, the UE transmits a PDU SESSION ESTABLISHMENT REQUEST message to the session management function (SMF) (e.g., at the core network (CN)) and starts a timer (e.g., T3580). The UE then receives a PDU SESSION ESTABLISHMENT ACCEPT message or a PDU SESSION ESTABLISHMENT REJECT message and stops the timer (e.g., as specified in 3GPP TS 24.501, FIG. 6.4.1.2.1).

In principle, after the PDU session is established in 5G 3GPP access, the network releases the existing PDN connection/PDU session (e.g., as specified in 3GPP TS 23.502, section 8.6.1 and 3GPP TS 23.502, sections 4.11.4 and 4.9.2). In particular, the UE and packet data network gateway (PGW)+SMF/user plane function (UPF) establishes a PDN connection (e.g., in evolved packet core (EPC)/ePDG). The UE then registers to a 5GC via 3GPP access, requests PDU session establishment (e.g., per 3GPP TS 23.502, section 4.3.2.2), and EPC and ePDG resources are released (e.g., per 3GPP TS 23.402, FIG. 7.9.2-1) (e.g., as described with regard to 3GPP TS 23.502, FIG. 4.11.4.1-1).

In practice, the network may release the IKE tunnel (IKE SA) over non-3GPP access or release a data radio bearer (DRB) over 3GPP access before the new PDU session is established over the 5G 3GPP/non-3GPP access, which incurs service interruption (e.g., a call drop) and impacts user experience. Notably, in 5G there are only two messages for PDU session establishment procedure. As such, the network does not confirm whether the PDU session has been successfully established in the UE.

### SUMMARY

An example embodiment of the techniques of this disclosure is a method implemented in a user equipment (CN) for performing handover enhancement among different accesses. The method includes: establishing, via a first access node, a first communication session with a user equipment (UE); receiving, from the UE via a second access node, a request to establish a second communication session; transmitting, to the UE via the second access node, an acceptance to the request; starting, responsive to the receiving of the request, a retransmission timer; and in a first instance, responsive to receiving an acknowledgement, from the UE via the second access node, that the second communication session is established: stopping the retransmission timer, and stopping communication with the UE via the first communication session; in a second instance, responsive to the retransmission timer expiring, retransmitting the acceptance.

Another example embodiment of these techniques is a core network (CN) comprising a transceiver and/or processing hardware configured to implement the method above.

### BRIEF DESCRIPTION OF THE DRAWINGS

FIG. 1 is an example message flow for a UE to handover an existing PDN connection/PDU session from the source access to 5G 3GPP/non-3GPP access;

FIG. 2 is an example message flow of enhancement by using 5GMM messages for a UE to handover an existing PDN connection/PDU session from the source access to 5G 3GPP/non-3GPP access;

FIG. 3 is an example message flow of enhancement by using 5GSM messages for a UE to handover an existing PDN connection/PDU session from the source access to 5G 3GPP/non-3GPP access; and

FIG. 4 is a flow diagram of an example method, implemented in a CN, for performing handover enhancement among different access nodes.

### DETAILED DESCRIPTION OF THE DRAWINGS

The techniques described below ensure/improve the service continuity when performing a handover for an existing PDN connection/PDU session from any access to 5G 3GPP/non-3GPP access.

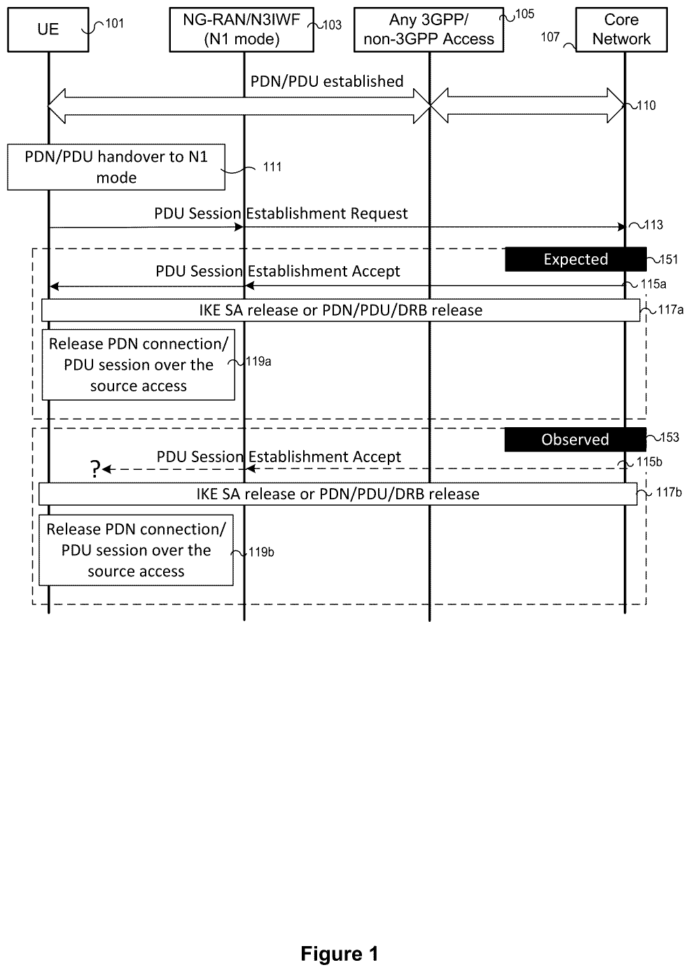

Referring first to FIG. 1, in step 110, a UE 101 has an established PDN connection or PDU session with the source access 105. The source access 105 can be at least one of: (i) 4G 3GPP access, (ii) 4G non-3GPP access (cPDG), (iii) 5G 3GPP access, and/or (iv) 5G non-3GPP access (N3IWF).

In step 111, the UE initiates a PDU session/PDN connection handover from the source access to 5G 3GPP/non-3GPP access (i.e., NI mode). In some implementations, step 111 is triggered due to out of WiFi coverage and/or based on network policy. The UE 101 then sends a PDU Session Establishment Request message with request type set to “existing PDU session” to the core network (also referred to as the “network 107”) over the 5G 3GPP/non-3GPP access (also referred to as the “target access 103”) in step 113.

Upon receipt of the PDU Session Establishment Request message, the network 107 is expected (as shown in procedure 151) to initiate the handover procedure and send an PDU Session Establishment Accept message to the UE over the 5G 3GPP/non-3GPP access 103 in step 115a, and the UE 101 establishes the PDU session over the target access 103. The network 107 then releases the corresponding IKE tunnel (IKE SA) over the source non-3GPP access (e.g., source access 105), or corresponding DRB over the source 3GPP access (e.g., source access 105), for the PDN connection or PDU session in step 117a. The UE 101 releases the PDN connection/PDU session over the source access 105 accordingly in step 119a.

However, in some cases (as shown in procedure 153), the UE 101 detects a network-initiated PDN connection or PDU session release procedure over the source access 105 in step 117b before the UE 101 receive PDU Session Establishment Accept message in step 115b. The reason why the UE 101 does not receive the PDU Session Establishment Accept message in step 115b may be, in various implementations, the message is lost or the network 107 did not send the message correctly. In such cases, as shown in procedure 153, the UE 101 releases the PDN connection/PDU session over the source access 105 at step 119b, the handover procedure fails, the on-going service is interrupted, and the PDU session status is not synchronized between the UE 101 and the network 107.

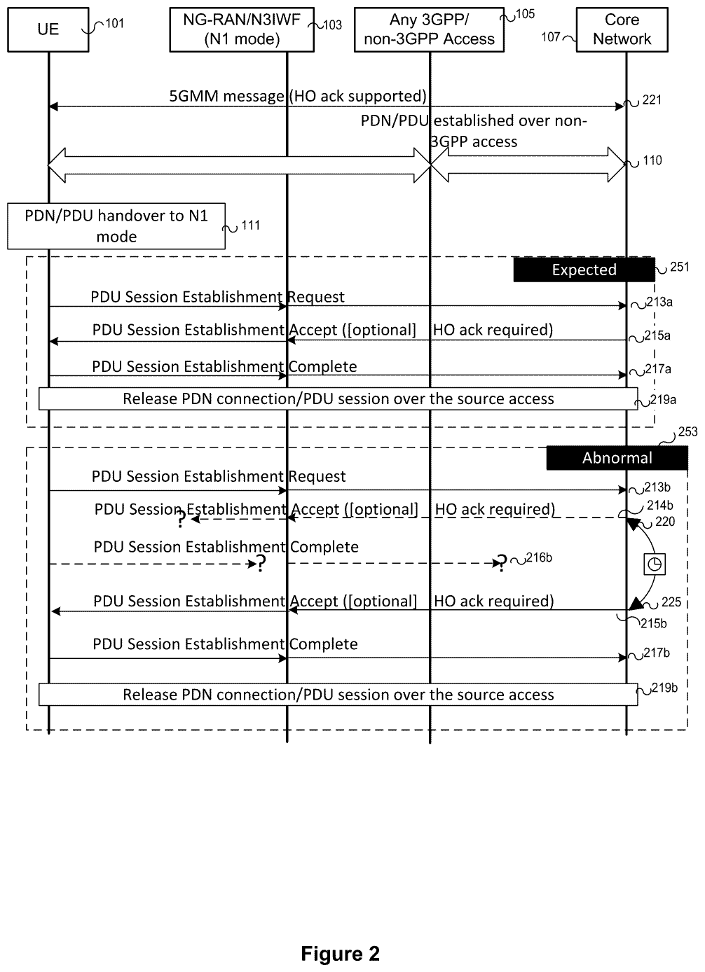

FIG. 2 illustrates a technique that improves the service continuity during handover procedure. Generally speaking, a new message (a third message) is introduced to the PDU session establishment procedure (e.g., a PDU Session Establishment Complete message) to inform the network that the UE 101 has received the PDU Session Establishment Accept message, and thus the PDU session has been successfully established over 5G 3GPP/non-3GPP access (e.g., the target access 103). The UE 101 and the network 107 negotiate the capability of the new message in a 5GMM procedure in step 221, for example in at least one of: (i) a registration procedure, (ii) a generic UE configuration update procedure, and/or (iii) a 5GMM Status procedure

The expected procedure 251 is illustrated in FIG. 2. When the UE 101 and the network 107 support the new message, upon receipt of the PDU Session Establishment Request message sent from the UE 101 in step 213a, the network 107 replies with a PDU Session Establishment Accept message and, optionally, includes an indication (e.g., handover acknowledgement required (HO ack required)) in step 215a. The indication indicates to the UE 101 whether the new message (PDU Session Establishment Complete) is required. If the new message (e.g., the HO ack) is required, the UE 101 replies with a PDU Session Establishment Complete message in step 217a. In some implementations, upon receipt of the acknowledgement, the network 107 releases the IKE tunnel (IKE SA) over non-3GPP access (e.g., the source access 105) or DRB over 3GPP access (e.g., the source access 105) in step 219a.

The abnormal procedure 253 is also illustrated in FIG. 2. After sending the PDU Session Establishment Accept message in step 214b in response to the PDU Session Establishment Request (e.g., of step 213b), the network 107 starts a retransmission timer in step 220. If the timer expires (e.g., at step 225) before receiving the PDU Session Establishment Complete message from the UE 101, the network 107 retransmits the PDU Session Establishment Accept message to the UE 101 in step 215b. The timer may expire because of at least one of the following: (i) the PDU Session Establishment Accept message sent by the network in step 214b is not successful and/or (ii) the PDU Session Establishment Complete message sent by the UE in step 216b is not successful.

Upon receipt of the PDU Session Establishment Accept message, the UE 101 replies with a PDU Session Establishment Complete message in step 217b. In some implementations, upon receipt of the acknowledgement, the network 107 releases the IKE tunnel (IKE SA) over non-3GPP access (e.g., source access 105) or DRB over 3GPP access (e.g., source access 105) in step 219b.

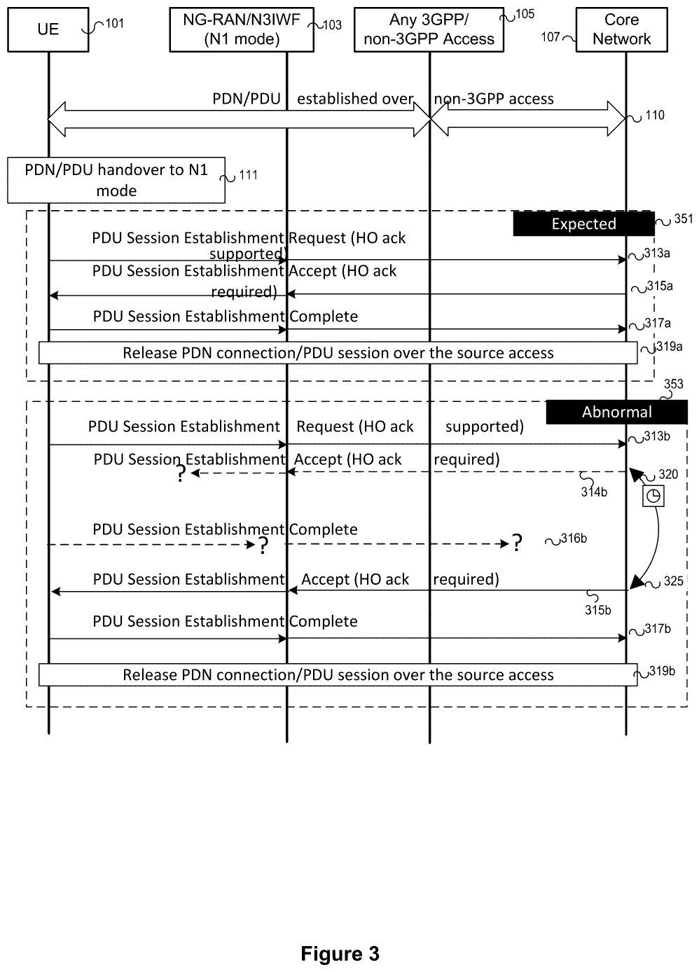

FIG. 3 illustrates an alternative solution to improve the service continuity during handover procedure that follows a similar principle as the solution illustrated in FIG. 2. In principle, a new message (e.g., a third message) is introduced to the PDU session establishment procedure (e.g., a PDU Session Establishment Complete message) to inform the network that the UE 101 has received the PDU Session Establishment Accept message, and thus the PDU session has been successfully established over the 5G 3GPP/non-3GPP access (e.g., the target access 103). The UE 101 and the network 107 negotiate the capability of the new message in a 5GSM procedure (e.g., a PDU session establishment procedure).

The expected procedure 351 is illustrated in FIG. 3. If the UE 101 supports the new message, when sending the PDU Session Establishment Request message, the UE 101 indicates to the network that the UE 101 supports and/or requires the handover acknowledgement (HO ack supported) in step 313a. Upon receipt of the PDU Session Establishment Request message sent from the UE 101 in step 313a, the network 107 replies with a PDU Session Establishment Accept message and optionally includes an indication (e.g., a handover acknowledgement required (HO ack required) indication) in step 315a. The indication indicates to the UE 101 whether the new message (e.g., the PDU Session Establishment Complete message) is required. If the new message (e.g., the HO ack) is required, the UE 101 replies with a PDU Session Establishment Complete message in step 317a. In some implementations, upon receipt of the acknowledgement, the network releases the IKE tunnel (IKE SA) over non-3GPP access (e.g., the source access 105) or the DRB over 3GPP access (e.g., the source access 105) in step 319a.

The abnormal procedure 353 is also illustrated in FIG. 3. After sending the PDU Session Establishment Accept message in step 314b, the network 107 starts a retransmission timer at step 320. If the timer expires (e.g., at step 325) before receiving the PDU Session Establishment Complete message from the UE 101, the network 107 retransmits the PDU Session Establishment Accept message to the UE 101 in step 315b. The timer may expire because of at least one of the following: (i) the PDU Session Establishment Accept message sent by the network 107 in step 314b is not successful and/or (ii) the PDU Session Establishment Complete message sent by the UE 101 in step 316b is not successful.

Upon receipt of the PDU Session Establishment Accept message, the UE 101 replies with a PDU Session Establishment Complete message in step 317b. In some implementations, upon receipt of the acknowledgement, the network 107 releases the IKE tunnel (IKE SA) over non-3GPP access (e.g., the source access 105) or the DRB over 3GPP access (e.g., the source access 105) in step 319b.

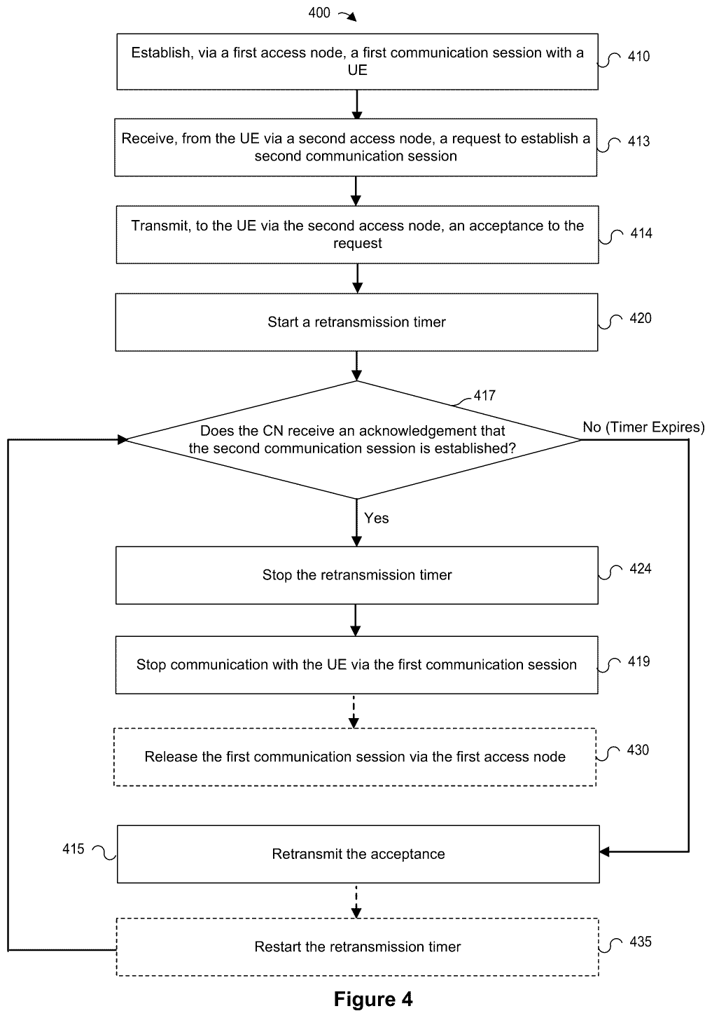

Next, example methods, which can be implemented in a CN (e.g., CN 107), are discussed next with reference to FIG. 4. Descriptions described for FIGS. 1-3 can apply to FIG. 4.

FIG. 4 illustrates an example method 400, which can be implemented by a UE (e.g., the UE 101).

The method 400 begins at block 410, where the CN establishes, via a first access node, a first communication session with a UE (e.g., event 110 of FIGS. 1-3). In various implementations, the first communication session is a PDU session, a PDN connection, etc. At block 413, the CN receives, from the UE via a second access node, a request to establish a second communication session (e.g., events 113, 213a, 213b, 313a, and/or 313b of FIGS. 1-3). Depending on the implementation, the second communication session is a 5GMM procedure session, a 5GSM procedure session, etc. In further implementations, the request includes an indication that the UE supports the handover acknowledgement operation. At block 414, the CN transmits, to the UE via the second access node, an acceptance to the request (e.g., events 115a, 115b, 215a, 214b, 315a, and/or 314b of FIGS. 1-3). In some implementations, the acceptance includes an indication to the UE to perform a handover acknowledgement operation. At block 420, the CN starts a retransmission timer (e.g., events 220b and/or 320b of FIGS. 2 and 3).

At block 417, the flow diverges based on whether the CN receives an acknowledgement that the second communication session is established (e.g., events 217a, 217b, 317a, and/or 317b of FIGS. 2 and 3). If the CN does receive the acknowledgement, then flow proceeds to block 424. At block 424, the CN stops the retransmission timer and, at block 419, stops communication with the UE via the first communication session (e.g., events 219a, 219b, 319a, and/or 319b of FIGS. 2 and 3). In some implementations, the flow proceeds to block 430, where the CN releases the first communication session via the first access node (e.g., events 219a, 219b, 319a, and/or 319b of FIGS. 2 and 3). In some such implementations, the CN releases the first communication as part of stopping communication with the UE via the first communication session. In further implementations, the first access node is an ePDG access node or an N3IWF access node, and releasing the first communication session includes releasing an IKE SA tunnel associated with the first communication session. In still further implementations, the first access node is an LTE access node or an NR access node, and releasing the first communication session includes releasing a DRB associated with the first communication session.

Otherwise, if the CN does not receive the acknowledgement, flow proceeds to block 415 upon expiration of the retransmission timer started in block 420. At block 415, the CN retransmits the acceptance message (e.g., events 215b and/or 315b of FIGS. 2 and 3). In some implementations, the flow proceeds to block 435, where the CN restarts the retransmission timer.

The following additional considerations apply to the foregoing discussion.

In some implementations, “message” is used and can be replaced by “information element (IE)”. In some implementations, “IE” is used and can be replaced by “field”. In some implementations, “configuration” can be replaced by “configurations” or the configuration parameters. In some implementations, “enable” can be replaced by “apply” or “store”. In some implementations, “disable” can be replaced by “delete” or “ignore”. In some implementations, “cell reselection” can be replaced by “cell selection”.

A user device in which the techniques of this disclosure can be implemented (e.g., the UE 102) can be any suitable device capable of wireless communications such as a smartphone, a tablet computer, a laptop computer, a mobile gaming console, a point-of-sale (POS) terminal, a health monitoring device, a drone, a camera, a media-streaming dongle or another personal media device, a wearable device such as a smartwatch, a wireless hotspot, a femtocell, or a broadband router. Further, the user device in some cases may be embedded in an electronic system such as the head unit of a vehicle or an advanced driver assistance system (ADAS). Still further, the user device can operate as an internet-of-things (IoT) device or a mobile-internet device (MID). Depending on the type, the user device can include one or more general-purpose processors, a computer-readable memory, a user interface, one or more network interfaces, one or more sensors, etc.

Certain embodiments are described in this disclosure as including logic or a number of components or modules. Modules may can be software modules (e.g., code stored on non-transitory machine-readable medium) or hardware modules. A hardware module is a tangible unit capable of performing certain operations and may be configured or arranged in a certain manner. A hardware module can comprise dedicated circuitry or logic that is permanently configured (e.g., as a special-purpose processor, such as a field programmable gate array (FPGA) or an application-specific integrated circuit (ASIC)) to perform certain operations. A hardware module may also comprise programmable logic or circuitry (e.g., as encompassed within a general-purpose processor or other programmable processor) that is temporarily configured by software to perform certain operations. The decision to implement a hardware module in dedicated and permanently configured circuitry, or in temporarily configured circuitry (e.g., configured by software) may be driven by cost and time considerations.

When implemented in software, the techniques can be provided as part of the operating system, a library used by multiple applications, a particular software application, etc. The software can be executed by one or more general-purpose processors or one or more special-purpose processors.

Upon reading this disclosure, those of skill in the art will appreciate still additional alternative structural and functional designs for alternative cell reselection priorities through the disclosed principles herein. Thus, while particular embodiments and applications have been illustrated and described, it is to be understood that the disclosed embodiments are not limited to the precise construction and components disclosed herein. Various modifications, changes and variations, which will be apparent to those of ordinary skill in the art, may be made in the arrangement, operation and details of the method and apparatus disclosed herein without departing from the spirit and scope defined in the appended claims.

What is claimed is:

1. A method implemented in a core network (CN), the method comprising:
establishing (410), via a first access node, a first communication session with a user equipment (UE);
receiving (413), from the UE via a second access node, a request to establish a second communication session;
transmitting (414), to the UE via the second access node, an acceptance to the request;
starting (420), responsive to the receiving of the request, a retransmission timer; and
in a first instance (251), responsive to receiving (417) an acknowledgement, from the UE via the second access node, that the second communication session is established:
stopping (424) the retransmission timer, and
stopping (419) communication with the UE via the first communication session;
in a second instance (253), responsive to the retransmission timer expiring (225), retransmitting (415) the acceptance.

2. The method of claim 1, wherein the second communication session is a fifth generation mobility management (5GMM) procedure session.

3. The method of claim 1, wherein the second communication session is a fifth generation session management (5GSM) procedure session.

4. The method of claim 1, wherein the request includes an indication that the UE supports handover acknowledgement.

5. The method of claim 1, wherein the acceptance includes an indication for handover acknowledgement.

6. The method of claim 1, further comprising:
releasing (430) the first communication session via the first access node responsive to the receiving of the acknowledgement.

7. The method of claim 6, wherein:
the first access node is an evolved packet data gateway (ePDG) access node or a non-third generation partnership project interworking function (N3IWF) access node; and
the releasing of the first communication session includes releasing an internet key exchange (IKE) security association (SA) tunnel associated with the first communication session.

8. The method of claim 6, wherein:
the first access node is a long term evolution (LTE) access node or a new radio (NR) access node; and
the releasing of the first communication session includes releasing a data radio bearer (DRB) associated with the first communication session.

9. The method of claim 1, further comprising:
in the second instance, restarting (435) the retransmission timer after the retransmitting of the acceptance.

10. The method of claim 1, wherein the first communication session is one of: (i) a protocol data unit (PDU) communication session or (ii) a packet data network (PDN) connection session.

11. An apparatus configured to function as a core network (CN), the apparatus including:
a transceiver; and
processing hardware, configured to:
establish (410), via a first access node, a first communication session with a user equipment (UE);
receive (413), from the UE via a second access node, a request to establish a second communication session;
transmit (414), to the UE via the second access node, an acceptance to the request;
start (420), responsive to receiving the request, a retransmission timer; and
in a first instance (251), responsive to receiving (417) an acknowledgement, from the UE via the second access node, that the second communication session is established:
stop (424) the retransmission timer, and
stop (419) communication with the UE via the first communication session;
in a second instance (253), responsive to the retransmission timer expiring (225), retransmit (415) the acceptance.

12. The apparatus of claim 11, wherein the second communication session is a fifth generation mobility management (5GMM) procedure session.

13. The apparatus of claim 11, wherein the second communication session is a fifth generation session management (5GSM) procedure session.

14. The apparatus of claim 11, wherein the request includes an indication that the UE supports handover acknowledgement.

15. The apparatus of claim 11, wherein the acceptance includes an indication for handover acknowledgement.

16. The apparatus of claim 11, wherein the processing hardware is further configured to:
release (430) the first communication session via the first access node responsive to receiving the acknowledgement.

17. The apparatus of claim 16, wherein:
the first access node is an evolved packet data gateway (ePDG) access node or a non-third generation partnership project interworking function (N3IWF) access node; and
releasing the first communication session includes releasing an internet key exchange (IKE) security association (SA) tunnel associated with the first communication session.

18. The apparatus of claim 16, wherein:
the first access node is a long term evolution (LTE) access node or a new radio (NR) access node; and
releasing the first communication session includes releasing a data radio bearer (DRB) associated with the first communication session.

19. The apparatus of claim 11, wherein the processing hardware is further configured to:
in the second instance, restart (435) the retransmission timer after retransmitting the acceptance.

20. The apparatus of claim 11, wherein the first communication session is one of: (i) a protocol data unit (PDU) communication session or (ii) a packet data network (PDN) connection session.
